(19) United States
(12) Patent Application Publication
(10) Pub. No.: US 2016/0266444 A1
(43) Pub. Date: Sep. 15, 2016

(54) LIQUID CRYSTSAL DISPLAY PANEL AND ARRAY SUBSTRATE THEREOF

(71) Applicant: SHENZHEN CHINA STAR OPTOELECTRONICS TECHNOLOGY CO., LTD., Shenzhen, Guangdong (CN)

(72) Inventor: Hua ZHENG, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/406,212

(22) PCT Filed: Sep. 30, 2014
(86) PCT No.: PCT/CN2014/087934

§ 371 Date: Dec. 6, 2014

(30) Foreign Application Priority Data
Sep. 24, 2014 (CN) 201410495731.8

(51) Int. Cl. G02F 1/1343; G02F 1/133; G02F 1/1368; G02F 1/1362

(52) U.S. Cl. CPC G02F 1/134309; G02F 1/136286; G02F 1/13306; G02F 1/1368; G02F 1/136209

(57) ABSTRACT

The present invention provides a liquid crystal display panel and array substrate thereof. The liquid crystal display panel comprises a first substrate and a second substrate, which is opposite to and spaced apart from the first substrate. The first substrate comprises a plurality of scan lines, a plurality of data lines and a plurality of pixel units defined by the scan lines and the data lines, wherein lengths of a plurality of pixel electrodes of the pixel units are decreased successively along a direction extended from a middle area of the liquid crystal display panel to a two-side area of the liquid crystal display panel, and widths of the pixel electrodes of the pixel units are the same. By the technique provided above, the present invention makes the liquid crystal display panel display uniform brightness such that the two-side whitening can be reduced or eliminated.

### FIELD OF THE INVENTION

The present invention relates to a technique field of liquid crystal display, and more particularly to a liquid crystal display panel and array substrate thereof.

### BACKGROUND OF THE INVENTION

When a TFT-LCD (Thin Film Transistor-Liquid Crystal Display) panel displays a low grey level image, there usually appears a poor display quality, so called as a two-side whitening, wherein the brightness in two-side area of the TFT-LCD is high and the brightness in the middle area of the TFT-LCD is low.

The reason why the two-side whitening occurred is that, as shown in FIG. 1, the driving voltage of the Gate line 11 is input from the scan driving electrode (Gate COF) 12 on the left and right side of the liquid crystal display panel 10, and the resistor R and capacitor C of the Gate line 11 results in RC delay, such that the voltage normally input from the two sides is distorted when it is transmitted to the middle area A, i.e. the Gate wave is distorted. The distorted voltage would reduce the charging ratio in the middle area A so that the brightness displayed at the middle area A is lowered. At this time, the brightness displayed at the two-side area B1 and B2 is higher than the brightness displayed at the middle area A1, i.e. the two-side whitening occurs. The two-side whitening is more obviously when displaying a low grey level image due to sensitivity of human eyes.

### SUMMARY OF THE INVENTION

Accordingly, the technique problem to be solved by the embodiment of the present invention is to provide a liquid crystal display panel and an array substrate thereof, such that the liquid crystal display panel displays uniform brightness and the two-side whitening can be reduced or eliminated.

In order to solve the technique problem above, the first technique solution adopted by the present invention is to provide a liquid crystal display panel comprising a first substrate and a second substrate, which is opposite to and spaced apart from the first substrate, wherein the first substrate comprises a plurality of scan lines, a plurality of data lines and a plurality of pixel units defined by the scan lines and the data lines, wherein lengths of a plurality of pixel electrodes of the pixel units are decreased successively along a direction extended from a middle area of the liquid crystal display panel to a two-side area of the liquid crystal display panel, and widths of the pixel electrodes of the pixel units are the same; and each of the pixel units is correspondingly coupled to one of the scan lines and one of the data lines, widths of the scan lines coupled to the corresponding pixel units are increased successively along the direction extended from the middle area of the liquid crystal display panel to the two-side area of the liquid crystal display panel, widths of the data lines coupled to the corresponding pixel units are the same, and length differences between the pixel electrodes of any two neighbored pixel units are the same.

Wherein, along the direction extended from the middle area of the liquid crystal display panel to the two-side area of the liquid crystal display panel, distances between the pixel electrodes of the pixel units and the correspondingly coupled scan lines are the same.

Wherein, along the direction extended from the middle area of the liquid crystal display panel to the two-side area of the liquid crystal display panel, width differences between the correspondingly coupled scan lines of any two neighbored pixel units are the same.

In order to solve the technique problem above, the other technique solution adopted by the present invention is to provide a liquid crystal display panel comprising a first substrate and a second substrate, which is opposite to and spaced apart from the first substrate, wherein the first substrate comprises a plurality of scan lines, a plurality of data lines and a plurality of pixel units defined by the scan lines and the data lines, wherein lengths of a plurality of pixel electrodes of the pixel units are decreased successively along a direction extended from a middle area of the liquid crystal display panel to a two-side area of the liquid crystal display panel, and widths of the pixel electrodes of the pixel units are the same.

Wherein, each of the pixel units is correspondingly coupled to one of the scan lines and one of the data lines, widths of the scan lines coupled to the corresponding pixel units are increased successively along the direction extended from the middle area of the liquid crystal display panel to the two-side area of the liquid crystal display panel, and widths of the data lines coupled to the corresponding pixel units are the same.

Wherein, along the direction extended from the middle area of the liquid crystal display panel to the two-side area of the liquid crystal display panel, distances between the pixel electrodes of the pixel units and the correspondingly coupled scan lines are the same.

Wherein, along the direction extended from the middle area of the liquid crystal display panel to the two-side area of the liquid crystal display panel, width differences between the correspondingly coupled scan lines of any two neighbored pixel units are the same.

Wherein, along the direction extended from the middle area of the liquid crystal display panel to the two-side area of the liquid crystal display panel, length differences between the pixel electrodes of any two neighbored pixel units are the same.

Wherein, the liquid crystal display panel further comprises a gate driver and a source driver, the gate driver is coupled to the scan lines for providing a scanning voltage to the pixel units, and the source driver is coupled to the data lines for providing a driving voltage to the pixel units.

Wherein, each of the pixel units further comprises a thin film transistor for driving the pixel unit, a size of each of the thin film transistors of the pixel units are the same, and a gate electrode, a source electrode and a drain electrode of the thin film transistor are electrically coupled to the scan line, the data line and the pixel electrode, respectively.

Wherein, the second substrate comprises a black matrix which is set corresponding to the scan line, and the width of the black matrix is greater than the width of the corresponding scan line.

In order to solve the technique problem above, the other technique solution adopted by the present invention is to provide an array substrate adapted to a liquid crystal display panel, wherein the array substrate comprises a plurality of scan lines, a plurality of data lines and a plurality of pixel units defined by the scan lines and the data lines, wherein lengths of a plurality of pixel electrodes of the pixel units are decreased successively along a direction extended from a middle area of the liquid crystal display panel to a two-side area of the liquid crystal display panel, and widths of the pixel electrodes of the pixel units are the same.

Wherein, each of the pixel units is correspondingly coupled to one of the scan lines and one of the data lines, widths of the scan lines coupled to the corresponding pixel units are increased successively along the direction extended from the middle area of the liquid crystal display panel to the two-side area of the liquid crystal display panel, and widths of the data lines coupled to the corresponding pixel units are the same.

Wherein, along the direction extended from the middle area of the liquid crystal display panel to the two-side area of the liquid crystal display panel, distances between the pixel electrodes of the pixel units and the correspondingly coupled scan lines are the same.

Wherein, along the direction extended from the middle area of the liquid crystal display panel to the two-side area of the liquid crystal display panel, width differences between the correspondingly coupled scan lines of any two neighbored pixel units are the same.

By applying the technique solution provided above, the beneficial effect of the embodiments of the present invention is: the embodiments of the present invention reduces aperture ratio and transmittance of the pixel units at the two-side area, such that the displayed brightness at the two-side area could be reduced, the brightness difference between the two-side area and the middle area could be reduced or eliminated, the liquid crystal display panel displays uniform brightness, and the two-side whitening can be reduced or eliminated by designing, along the direction extended from the middle area of the liquid crystal display panel to the two-side area of the liquid crystal display panel, the lengths of the pixel electrodes of the pixel units are successively reduced and the widths thereof are the same.

### BRIEF DESCRIPTION OF THE DRAWINGS

FIG. 1 is a structural top view of a conventional liquid crystal display panel.

FIG. 2 is a sectional view of a liquid crystal display panel according to a preferred embodiment of the present invention.

FIG. 3 is a top view of a liquid crystal display panel according to a preferred embodiment of the present invention.

FIG. 4 is a pixel structure schematic diagram of a liquid crystal display panel according to a preferred embodiment of the present invention.

FIG. 5 is a structural schematic diagram of the pixel unit at the two-side area of the liquid crystal display panel shown in FIG. 3.

FIG. 6 is a structural schematic diagram of the pixel unit at middle area of the liquid crystal display panel shown in FIG. 3.

FIG. 7 is a schematic diagram shown the corresponding relationship between the aperture ratio of the pixel unit and length of the pixel electrode in the liquid crystal display panel shown in FIG. 3.

### DETAILED DESCRIPTION OF PREFERRED EMBODIMENTS

The technique solutions in the embodiments of the present invention are described clearly and completely below with reference to the attached drawings of the embodiments of the present invention. Obviously, the embodiments described below are a part of embodiments but not all embodiments of the present invention. All other embodiments obtained by those have ordinary skill in the field based on the embodiments of the present invention without creative effort are within the protection scope of the present invention.

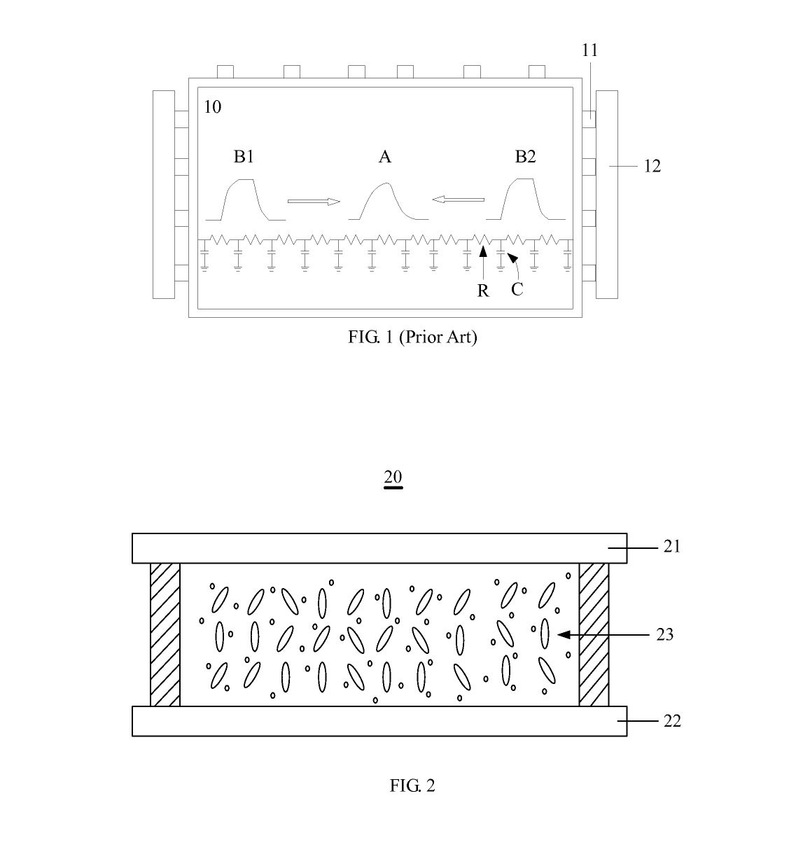

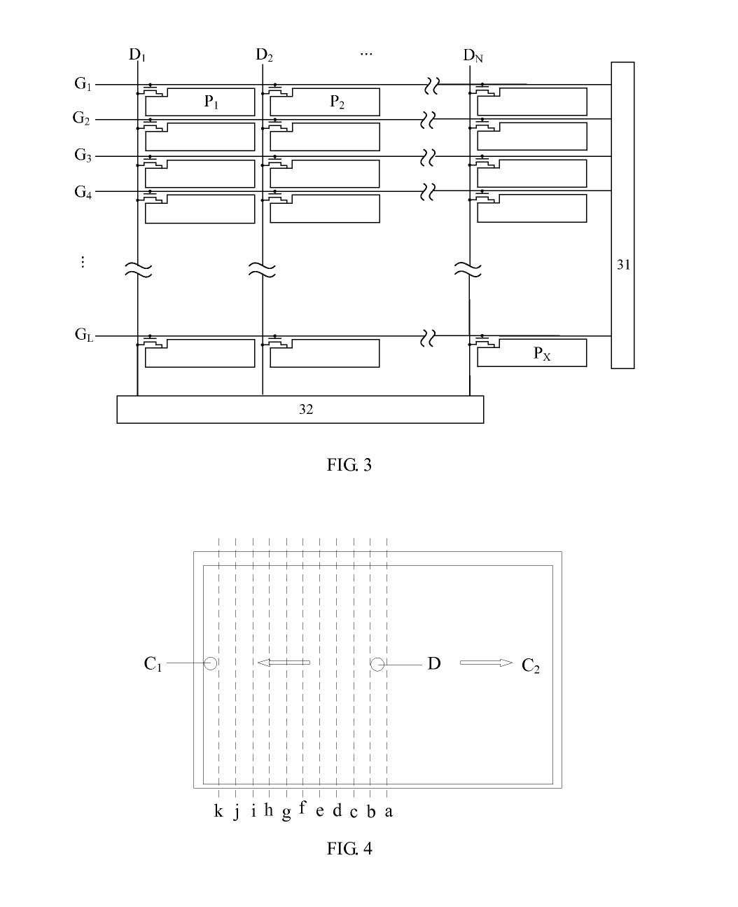

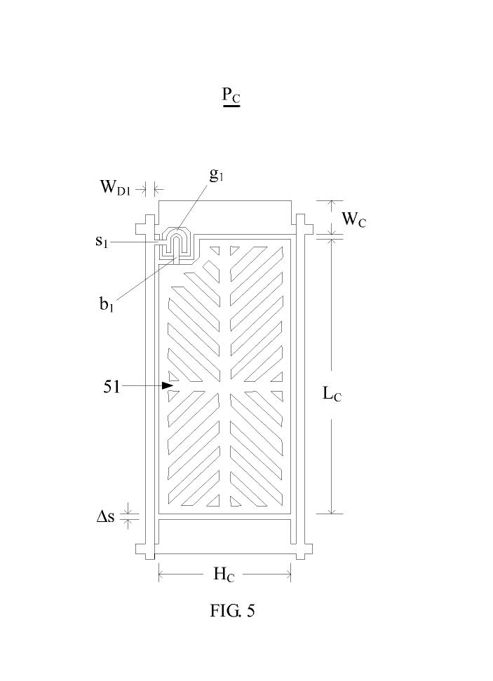

FIG. 2 and FIG. 3 are a sectional view and a top view of a liquid crystal display panel according to a preferred embodiment of the present invention, respectively. FIG. 4 is a pixel structure schematic diagram of the liquid crystal display panel. Referring with FIG. 2˜FIG. 4, the liquid crystal display panel 20 comprises a first substrate 21, a second substrate 22 and a liquid crystal layer 23, wherein the first substrate 21 and the second substrate 22 are spaced apart and set oppositely. The second substrate 22 is a CF (Color Filter) colour film substrate and the first substrate 21 is a TFT (Thin Film Transistor) array substrate. The first substrate 21 comprises a transparent body, and various traces and pixel electrodes etc. set on the transparent body.

Specifically, the first substrate 21 comprises a plurality of data lines D₁, D₂, . . . , D_{N}, a plurality of scan lines G₁, G₂, . . . , G_{L} set along a direction vertical to the data lines, and a plurality of pixel units P₁, P₂, . . . , P_{X} defined by the scan lines G₁, G₂, . . . , G_{L} and the data lines D₁, D₂, . . . , D_{N}. Each of the pixel units is correspondingly coupled to a scan line and a data line.

Wherein, the scan lines G₁, G₂, . . . , G_{L} are coupled to the gate driver 31, and the data lines D₁, D₂, . . . , D_{N} are coupled to the source driver 32. The gate driver 31 provides a scanning voltage to the pixel units P₁, P₂, . . . , P_{X}, and the source driver 32 provides a driving voltage to the pixel units P₁, P₂, . . . , P_{X}.

The main object of the embodiment according to the present invention is to successively reduce the length of the pixel electrodes of the pixel units P₁, P₂, . . . , P_{X} along a direction extended from the middle area D of the liquid crystal display panel 20 to the two-side areas C₁ and C₂ of the liquid crystal display panel 20, i.e. the direction of the arrows shown in FIG. 4, and the widths of the pixel electrodes of the pixel units P₁, P₂, . . . , P_{X} are the same.

According to the common knowledge of the liquid crystal display field: the transmittance of the pixel unit=aperture ratio* efficiency of liquid crystal (i.e. transmittance of unit aperture area), the aperture area and the efficiency of liquid crystal can be lowered by reducing the length of the pixel electrode, such that the displayed brightness at the two-side areas C₁ and C₂ could be lowered. At this time, the brightness difference between the two-side areas C₁ and C₂and the middle area D could be reduced or even eliminated, the brightness would be displayed on liquid crystal display panel 20 more uniformly, so that the two-side whitening can be reduced or eliminated.

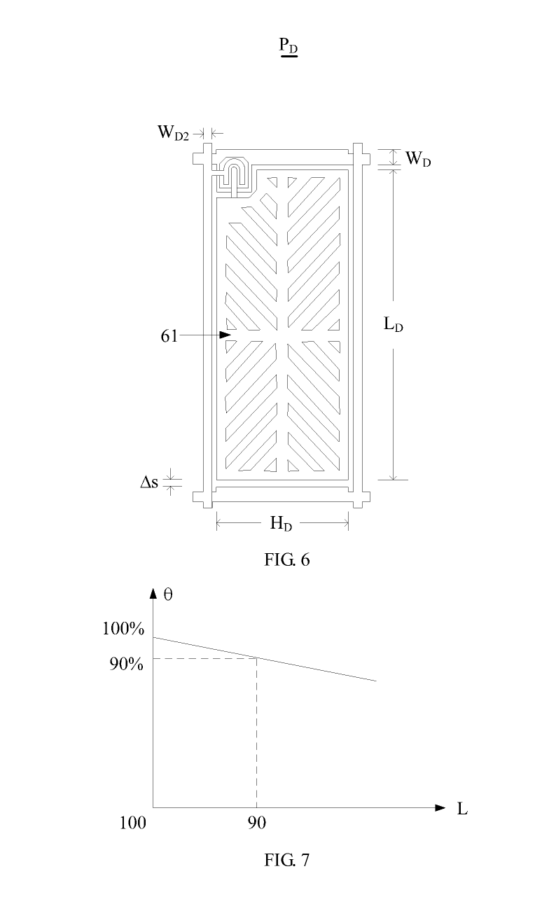

Based on the object of the present invention described above, the structures of the pixel units P₁, P₂, . . . , P_{X} are different. Preferably, the widths of the correspondingly coupled scan lines G₁, G₂, . . . , G_{L} and the lengths of the pixel electrodes of the pixel units P₁, P₂, . . . , P_{X} are different. The description made below takes a pixel unit P_{D} shown in FIG. 5, which is in the middle area D of the liquid crystal display panel 20, and a pixel unit P_{C} shown in FIG. 6, which is in the two-side area (C₁) of the liquid crystal display panel 20, as an example.

Please refer to FIG. 5 and FIG. 6, the length of the pixel electrode 51 of the pixel unit P_{C} in the two-side area C₁ is L_{C}, the width of the pixel electrode 51 of the pixel unit P_{C} is H_{C}, the length of the pixel electrode 61 of the pixel unit P_{D} in the middle area D is L_{D}, and the width of the pixel electrode 61 of the pixel unit P_{D} is H_{D}. Wherein, L_{C}<L_{D} and H_{C}=H_{D}.

Besides, along the direction extended from the middle area D to the two-side areas C₁ and C₂, it is preferred in the present embodiment that the length differences between the pixel electrodes of any two neighbored pixel units are the same. That is, the lengths of the pixel electrodes of the pixel units P₁, P₂, . . . , P_{X} are successively reduced with the same value. Please refer to the example provided below.

With reference to FIG. 3, 11 regions a, b, c, d, e, f, g, h, i, j, and k are selected along the direction extended from the middle area D to the two-side area C1, wherein the length of the pixel electrode corresponding to the region a is 100, the length of the pixel electrode corresponding to the region b is 99, the length of the pixel electrode corresponding to the region c is 98, the length of the pixel electrode corresponding to the region d is 97, the length of the pixel electrode corresponding to the region e is 96, the length of the pixel electrode corresponding to the region f is 95, the length of the pixel electrode corresponding to the region g is 94, the length of the pixel electrode corresponding to the region h is 93, the length of the pixel electrode corresponding to the region i is 92, the length of the pixel electrode corresponding to the region j is 91, and the length of the pixel electrode corresponding to the region k is 90. The length unit of the pixel electrode is micrometer um.

Moreover, the length differences between the pixel electrodes of the pixel units corresponding to region a and region b, region b and region c, region c and region d, region d and region e, region e and region f, region f and region g, region g and region h, region h and region i, region i and region j, and region j and region k are the same, i.e. l micrometer.

It is noted that, along a gravity direction which is vertical to the direction extended from the middle area D to the two-side areas C₁ and C₂, the structure and size of the pixel electrode and the correspondingly coupled data line of the pixel unit corresponding to each region is preferably the same in the embodiment according to the present invention.

With reference to FIG. 7, the width of the pixel electrodes of the pixel units P₁, P₂, . . . , P_{X} remain unchanged and therefore the relationship between the aperture ratio θ of the pixel unit and the length L of the pixel electrode is linear. When the value of L is reduced from 100 um to 90 um, the aperture ratio θ of the pixel unit is reduced to 90%, i.e. the transmittance of the pixel unit is reduced to 90%, such that the two-side whitening can be greatly reduced.

Furthermore, along the direction extended from the middle area D to the two-side areas C₁ and C₂, it is preferred in the present embodiment that the widths of the correspondingly coupled scan lines of any two neighbored pixel units are successively increased, and the widths of the correspondingly coupled data lines are the same.

Specifically, please refer to FIG. 5 and FIG. 6 again, the width of the scan line G_{C} correspondingly coupled to the pixel electrode 51 of the pixel unit P_{C} in the two-side areas C₁ and C₂ is W_{C}, the width of the data line D_{C} correspondingly coupled to the pixel electrode 51 is W_{D1}, the width of the scan line G_{D} correspondingly coupled to the pixel electrode 61 of the pixel unit P_{D} in the middle area D is W_{D}, and the width of the data line D_{D} correspondingly coupled to the pixel electrode 61 is W_{D2}. Wherein, W_{C}>W_{D} and W_{D1}=W_{D2}.

For the same reason, in the successively neighbored 11 regions a, b, c, d, e, f, g, h, i, j, and k, the width of the scan line correspondingly coupled to the pixel electrode corresponding to the region a is 10, the width of the scan line correspondingly coupled to the pixel electrode corresponding to the region b is 11, the width of the scan line correspondingly coupled to the pixel electrode corresponding to the region c is 12, the width of the scan line correspondingly coupled to the pixel electrode corresponding to the region d is 13, the width of the scan line correspondingly coupled to the pixel electrode corresponding to the region e is 14, the width of the scan line correspondingly coupled to the pixel electrode corresponding to the region f is 15, the width of the scan line correspondingly coupled to the pixel electrode corresponding to the region g is 16, the width of the scan line correspondingly coupled to the pixel electrode corresponding to the region h is 17, the width of the scan line correspondingly coupled to the pixel electrode corresponding to the region i is 18, the width of the scan line correspondingly coupled to the pixel electrode corresponding to the region j is 19, and the width of the scan line correspondingly coupled to the pixel electrode corresponding to the region k is 20. The width unit of the scan line is micrometer um.

Wherein, the width differences between the scan lines correspondingly coupled to any two neighbored pixel units are the same, i.e. the width differences between the correspondingly coupled scan lines of the pixel units corresponding to region a and region b, region b and region c, region c and region d, region d and region e, region e and region f, region f and region g, region g and region h, region h and region i, region i and region j, and region j and region k are the same, i.e. l micrometer.

Moreover, it is preferred in the present embodiment that the distances Δs between the pixel electrodes of the pixel units P₁, P₂, . . . , P_{X} and the scan lines correspondingly coupled thereto are the same.

According to the descriptions made above, the aperture area of the pixel electrode in the two-side areas of the liquid crystal display panel is successively reduced region by region in the embodiment of the present invention, such that the transmittance of the pixel unit in the two-side areas of the liquid crystal display panel would be reduced for compensating the difference of charging ratio between the two-side areas and the middle area. At the same time, compared to the aperture area of the conventional pixel unit, the surplus space is used for increasing the width of the scan lines.

For example, an area of a pixel unit is defined as 45 um*135 um. In the middle area, the length of the aperture area of the pixel electrode (i.e. the pixel electrode) is 100 um, the width of the scan line is 10 um, and the distance between the aperture area of the pixel electrode and the scan line is 15 um. Equally dividing each of the two-side areas into 10 regions, successively decreasing the length of the pixel electrode in each region for 1 um and successively increasing the width of the scan line for 1 um, and therefore the length of the pixel electrode in the outermost region is 90 um, and the width of the scan line is 20 um. Preferably, the embodiment proceeds the region design while designing light masks. Through the conventional optical lithography process, the design of the embodiment according to the present invention can be realized on the layers of the liquid crystal display panel where the scan lines and the pixel electrodes are.

Furthermore, the increased width of the scan line in the embodiment of the present invention could reduce the resistor R of the scan line so as to reduce the RC Delay of the scan line, and distortion occurred when the voltage input from the two-side areas C₁ and C₂ is transmitted to the middle area D can be prevented or reduced, i.e. the Gate waveform would not be distorted and the two-side whitening could be further improved.

It is noted that, although the capacitor C is also increased when the width of the scan line is increased, the increased effect due to the capacitor C is far less than the reduced effect due to the resistor R such that the RC constant is reduced, i.e. the RC Delay is reduced.

Please refer to FIG.3˜FIG. 6, each pixel unit of the present embodiment further comprises a thin film transistor for driving the pixel electrode, and the structures and sizes of the thin film transistors of the pixel units P₁, P₂, . . . , P_{X} are the same. Each thin film transistor comprises a gate electrode g₁, a source electrode s₁ and a drain electrode b₁, wherein the gate electrode g₁ is electrically coupled to the corresponding scan line, the source electrode s₁ is electrically coupled to the corresponding data line, and the drain electrode b₁ is electrically coupled to the corresponding pixel electrode.

Due to the successively increased width of the scan line along the direction extended from the middle area D to the two-side areas C₁ and C₂ in the embodiment of the present invention, the width of each of the black matrices set on the second substrate 22 corresponding to the scan lines shown in FIG. 2 is greater than the width of the corresponding scan line.

In summary, the embodiments of the present invention reduces aperture ratio and transmittance of the pixel units at the two-side areas, such that the displayed brightness at the two-side areas could be reduced, the brightness difference between the two-side areas and the middle area could be reduced or eliminated, the liquid crystal display panel displays uniform brightness, and the two-side whitening can be reduced or eliminated by designing, along the direction extended from the middle area of the liquid crystal display panel to the two-side areas of the liquid crystal display panel, the lengths of the pixel electrodes of the pixel units are successively reduced and the widths thereof are the same.

It is again noted that, the descriptions made above are the embodiments of the present invention, and are not used for limiting the protection scope of the present invention. All equivalent structures or flow variations made according to the contents of the specification and attached drawings of the present invention, such as combining technique features of the embodiments or applying, either directly or indirectly, them into other related technique fields, are included in the patent protection scope of the present invention.

What is claimed is:

1. A liquid crystal display panel, comprising a first substrate and a second substrate, which is opposite to and spaced apart from the first substrate, wherein the first substrate comprises a plurality of scan lines, a plurality of data lines and a plurality of pixel units defined by the scan lines and the data lines,
wherein lengths of a plurality of pixel electrodes of the pixel units are decreased successively along a direction extended from a middle area of the liquid crystal display panel to a two-side area of the liquid crystal display panel, and widths of the pixel electrodes of the pixel units are the same; and
each of the pixel units is correspondingly coupled to one of the scan lines and one of the data lines, widths of the scan lines coupled to the corresponding pixel units are increased successively along the direction extended from the middle area of the liquid crystal display panel to the two-side area of the liquid crystal display panel, widths of the data lines coupled to the corresponding pixel units are the same, and length differences between the pixel electrodes of any two neighbored pixel units are the same.

2. The liquid crystal display panel according to claim 1, wherein, along the direction extended from the middle area of the liquid crystal display panel to the two-side area of the liquid crystal display panel, distances between the pixel electrodes of the pixel units and the correspondingly coupled scan lines are the same.

3. The liquid crystal display panel according to claim 2, wherein, along the direction extended from the middle area of the liquid crystal display panel to the two-side area of the liquid crystal display panel, width differences between the correspondingly coupled scan lines of any two neighbored pixel units are the same.

4. A liquid crystal display panel, comprising a first substrate and a second substrate, which is opposite to and spaced apart from the first substrate, wherein the first substrate comprises a plurality of scan lines, a plurality of data lines and a plurality of pixel units defined by the scan lines and the data lines,
wherein lengths of a plurality of pixel electrodes of the pixel units are decreased successively along a direction extended from a middle area of the liquid crystal display panel to a two-side area of the liquid crystal display panel, and widths of the pixel electrodes of the pixel units are the same.

5. The liquid crystal display panel according to claim 4, wherein each of the pixel units is correspondingly coupled to one of the scan lines and one of the data lines, widths of the scan lines coupled to the corresponding pixel units are increased successively along the direction extended from the middle area of the liquid crystal display panel to the two-side area of the liquid crystal display panel, and widths of the data lines coupled to the corresponding pixel units are the same.

6. The liquid crystal display panel according to claim 5, wherein, along the direction extended from the middle area of the liquid crystal display panel to the two-side area of the liquid crystal display panel, distances between the pixel electrodes of the pixel units and the correspondingly coupled scan lines are the same.

7. The liquid crystal display panel according to claim 5, wherein, along the direction extended from the middle area of the liquid crystal display panel to the two-side area of the liquid crystal display panel, width differences between the correspondingly coupled scan lines of any two neighbored pixel units are the same.

8. The liquid crystal display panel according to claim 4, wherein, along the direction extended from the middle area of the liquid crystal display panel to the two-side area of the liquid crystal display panel, length differences between the pixel electrodes of any two neighbored pixel units are the same.

9. The liquid crystal display panel according to claim 4, wherein the liquid crystal display panel further comprises a gate driver and a source driver, the gate driver is coupled to the scan lines for providing a scanning voltage to the pixel units, and the source driver is coupled to the data lines for providing a driving voltage to the pixel units.

10. The liquid crystal display panel according to claim 4, wherein each of the pixel units further comprises a thin film transistor for driving the pixel unit, a size of each of the thin film transistors of the pixel units are the same, and a gate electrode, a source electrode and a drain electrode of the thin film transistor are electrically coupled to the scan line, the data line and the pixel electrode, respectively.

11. The liquid crystal display panel according to claim 4, wherein the second substrate comprises a black matrix which is set corresponding to the scan line, and the width of the black matrix is greater than the width of the corresponding scan line.

12. An array substrate adapted to a liquid crystal display panel, wherein the array substrate comprises a plurality of scan lines, a plurality of data lines and a plurality of pixel units defined by the scan lines and the data lines,
wherein lengths of a plurality of pixel electrodes of the pixel units are decreased successively along a direction extended from a middle area of the liquid crystal display panel to a two-side area of the liquid crystal display panel, and widths of the pixel electrodes of the pixel units are the same.

13. The array substrate according to claim 12, wherein each of the pixel units is correspondingly coupled to one of the scan lines and one of the data lines, widths of the scan lines coupled to the corresponding pixel units are increased successively along the direction extended from the middle area of the liquid crystal display panel to the two-side area of the liquid crystal display panel, and widths of the data lines coupled to the corresponding pixel units are the same.

14. The array substrate according to claim 13, wherein, along the direction extended from the middle area of the liquid crystal display panel to the two-side area of the liquid crystal display panel, distances between the pixel electrodes of the pixel units and the correspondingly coupled scan lines are the same.

15. The array substrate according to claim 13, wherein, along the direction extended from the middle area of the liquid crystal display panel to the two-side area of the liquid crystal display panel, width differences between the correspondingly coupled scan lines of any two neighbored pixel units are the same.
